(19) United States
(12) Patent Application Publication
(10) Pub. No.: US 2015/0265948 A1
(43) Pub. Date: Sep. 24, 2015

(54) REINFORCED OIL FILTER CHECK VALVE

(71) Applicant: Parker-Hannifin Corporation, Cleveland, OH (US)

(72) Inventors: Max George Ellison, Lynchburg, VA (US); Nigel Goulding, Lynchburg, VA (US)

(21) Appl. No.: 14/666,891

(22) Filed: Mar. 24, 2015

Related U.S. Application Data
(60) Provisional application No. 61/969,205, filed on Mar. 23, 2014.

(51) Int. Cl. B01D 27/10; F01M 11/03

(52) U.S. Cl. CPC B01D 27/106; F01M 11/03; B01D 27/103

(57) ABSTRACT

An anti-drainback/bypass valve for an oil filter having an annular base portion, a resiliently deflectable annular anti-drainback skirt extending radially outwardly from the base portion, and a resiliently deflectable annular bypass skirt extending radially inwardly from the base portion, wherein the base portion is characterized by being stiffer than the resiliently deflectable anti-drainback skirt and the resiliently deflectable bypass skirt. By stiffening the base portion, a hinge area of the resiliently deflectable bypass skirt is controlled to open at relatively high pressures. Controlling the hinge area prevents failure of the resiliently deflectable bypass skirt at pressures below a prescribed criteria, which prevents unfiltered oil from bypassing a filter element when the filter element is not clogged.

### RELATED APPLICATION DATA

This application claims the benefit of U.S. Provisional Application No. 61/969,502 filed Mar. 24, 2014, which is hereby incorporated herein by reference.

### FIELD OF INVENTION

The present invention relates generally to oil filters, and more particularly to a combination anti-drainback/bypass valve for an oil filter.

### BACKGROUND

Fluid filters, such as spin-on type filters are used generally for filtering lubricating oil in internal combustion engines, particularly automotive vehicle engines. The fluid filters may be provided with a valve, such as an anti-drainback valve to trap fluid in the filter and prevent the fluid from leaking out of the filter when an engine of the vehicle is turned off. The fluid filters may be provided with another valve, such as a bypass valve, which is biased in a closed position and which opens to permit direct communication between an inlet of the filter and an outlet of the filter when the filter becomes clogged so that the vehicle engine is not starved for lubrication.

### SUMMARY OF INVENTION

The present invention provides a combination anti-drainback/bypass valve for an oil filter having an annular base portion, a resiliently deflectable annular anti-drainback skirt extending radially outwardly from the base portion, and a resiliently deflectable annular bypass skirt extending radially inwardly from the base portion, wherein the base portion is characterized by being stiffer than the resiliently deflectable anti-drainback skirt and the resiliently deflectable bypass skirt. By stiffening the base portion, a hinge area of the resiliently deflectable bypass skirt is controlled to open at relatively high pressures. Controlling the hinge area prevents failure of the resiliently deflectable bypass skirt at pressures below a prescribed criteria, which prevents unfiltered oil from bypassing a filter element when the filter element is not clogged.

According to one aspect of the invention a combination anti-drainback/bypass valve for an oil filter is provided. The combination anti-drainback/bypass valve includes an annular base portion, a resiliently deflectable annular anti-drainback skirt extending radially outwardly from the base portion, and a resiliently deflectable annular bypass skirt extending radially inwardly from the base portion, wherein the base portion is characterized by being stiffer than the resiliently deflectable anti-drainback skirt and the resiliently deflectable bypass skirt.

The base portion may be unitary with the resiliently deflectable anti-drainback skirt and the resiliently deflectable bypass skirt.

The valve may include an annular ring member that interacts with the base portion to impart a greater stiffness on the base portion than the resiliently deflectable anti-drainback skirt and the resiliently deflectable bypass skirt.

The annular ring member may be embedded in the base portion.

The annular ring member may be embedded in the base portion between the resiliently deflectable anti-drainback skirt and the resiliently deflectable bypass skirt.

The resiliently deflectable annular anti-drainback skirt may extend from the base portion radially outwardly and axially in a first direction.

The resiliently deflectable annular bypass skirt may extend from the base portion radially inwardly and axially in a first direction.

The resiliently deflectable anti-drainback skirt may extend from the base portion in the first direction a distance greater than the resiliently deflectable bypass skirt extends from the base portion in the first direction.

The base portion, the resiliently deflectable anti-drainback skirt, and the resiliently deflectable bypass skirt may be made from the same material.

The base portion may define a fluid passage therethrough.

The resiliently deflectable anti-drainback skirt and the resiliently deflectable bypass skirt each may have a sealing portion for sealing to a base member.

The resiliently deflectable bypass skirt may be movable from a first position to a second position by a fluid pressure at or above a prescribed criteria.

The prescribed criteria may be a pressure of twenty psi.

According to another aspect of the invention, a combination anti-drainback/bypass valve for an oil filter is provided. The combination anti-drainback/bypass valve includes an annular base portion, a first annular check valve member extending radially outwardly from the annular base portion, a second annular check valve member extending radially inwardly from the annular base portion, and a relatively rigid annular support member embedded in the annular base portion.

The relatively rigid annular support member may impart a greater stiffness to the annular base portion than the first and second check valve members.

The annular base portion may be unitary with the first annular check valve member and the second annular check valve member.

The annular support member may be embedded in the base portion between the first check valve member and the second check valve member.

The first and second check valve members may be resiliently deflectable.

The first annular check valve member may extend from the annular base portion radially outwardly and axially in a first direction.

The second annular check valve member may extend from the annular base portion radially inwardly and axially in a first direction.

The first check valve member may extend from the base portion in the first direction a distance greater than the second check valve member extends from the base portion in the first direction.

The base portion, the first check valve member, and the second check valve member may be made from the same material.

The base portion may define a fluid passage therethrough.

The first and second check valve members each may have a sealing portion for sealing to a base member.

The second annular check valve member may be movable from a first position to a second position by a fluid pressure at or above a prescribed criteria.

The prescribed criteria may be a pressure of twenty psi.

According to still another aspect of the invention, an oil filter is provided that includes a housing including a canister having a closed end and an open end, a base plate attached to the open end of the canister and defining an internal chamber therewith, the base plate including a plurality of circumferentially spaced inlet ports for directing unfiltered fluid into the internal chamber, an outlet port surrounded by the inlet ports for expelling filtered fluid from the chamber, and a plurality of circumferentially spaced bypass ports between the inlet ports and the outlet port for directing fluid to the outlet port, a filter element disposed in the chamber, and a combination anti-drainback/bypass valve disposed in the chamber between the base plate and the filter element, the combination valve including a base portion, a resiliently deflectable annular anti-drainback skirt extending radially outwardly from the base portion for allowing fluid flow from the inlet ports to the filter element, and a resiliently deflectable annular bypass skirt extending radially inwardly from the base portion for allowing fluid flow to bypass the filter element and flow to the outlet port, wherein the base portion is characterized by being stiffer than the resiliently deflectable anti-drainback skirt and the resiliently deflectable bypass skirt.

An annular ring member may be embedded in the base portion to impart a greater stiffness on the base portion than the resiliently deflectable anti-drainback skirt and the resiliently deflectable bypass skirt.

The resiliently deflectable anti-drainback skirt and the resiliently deflectable bypass skirt each may have a sealing portion for sealing to the base member.

The filter may further include a biasing member that applies a load to the filter element to bias the filter element against the combination valve to hold the combination valve against the base plate.

The resiliently deflectable annular bypass skirt may be movable from a first position sealing against the base plate to a second position allowing fluid to bypass the filter element and flow to the outlet port by a fluid pressure at or above a prescribed criteria.

The prescribed criteria may be a pressure of twenty psi.

The foregoing and other features of the invention are hereinafter described in greater detail with reference to the accompanying drawings.

### BRIEF DESCRIPTION OF THE DRAWINGS

FIG. 1 is a perspective view of an exemplary oil filter.

FIG. 2 is a cross-sectional view of an oil filter including a combination anti-drainback/bypass valve according to the invention.

FIG. 3 is a perspective view of a base plate and combination anti-drainback/bypass valve.

FIG. 4 is a perspective view of the combination anti-drainback/bypass valve.

FIG. 5 is another perspective view of the combination anti-drainback/bypass valve.

FIG. 6 is a cross-sectional view of the combination anti-drainback/bypass valve.

### DETAILED DESCRIPTION

The principles of the present invention have particular application to fluid filters for filtering lubricating oil in internal combustion engines, and thus will be described below chiefly in this context. It will of course be appreciated, and also understood, that the principles of the invention may be useful in other filtration applications where it is desirable to filter particulates from fluid and bypass the filter when it is clogged.

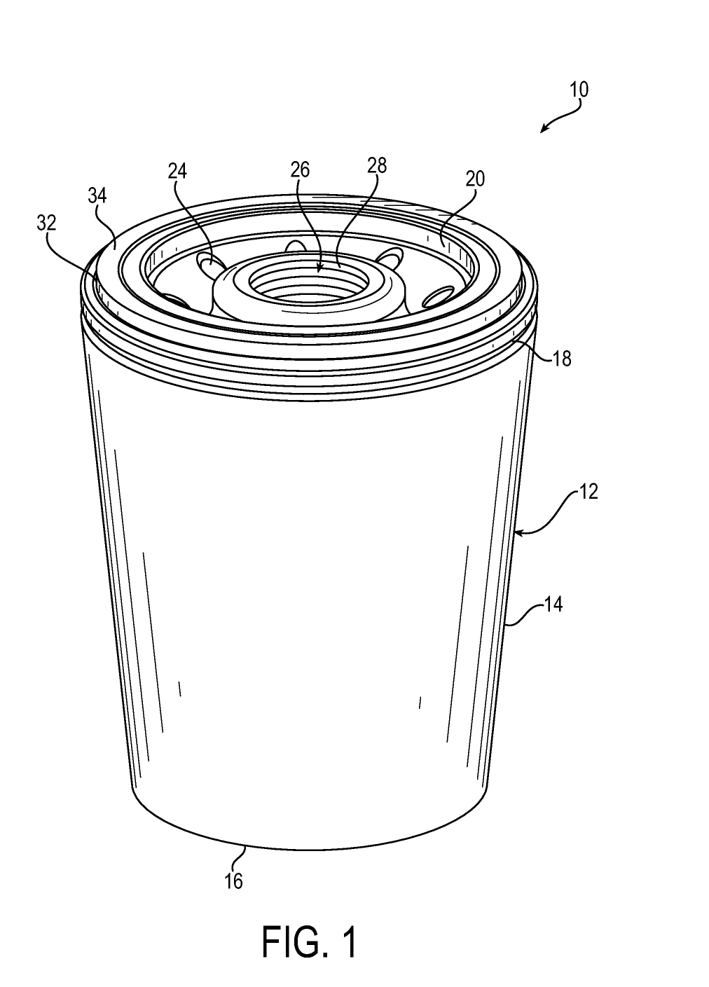

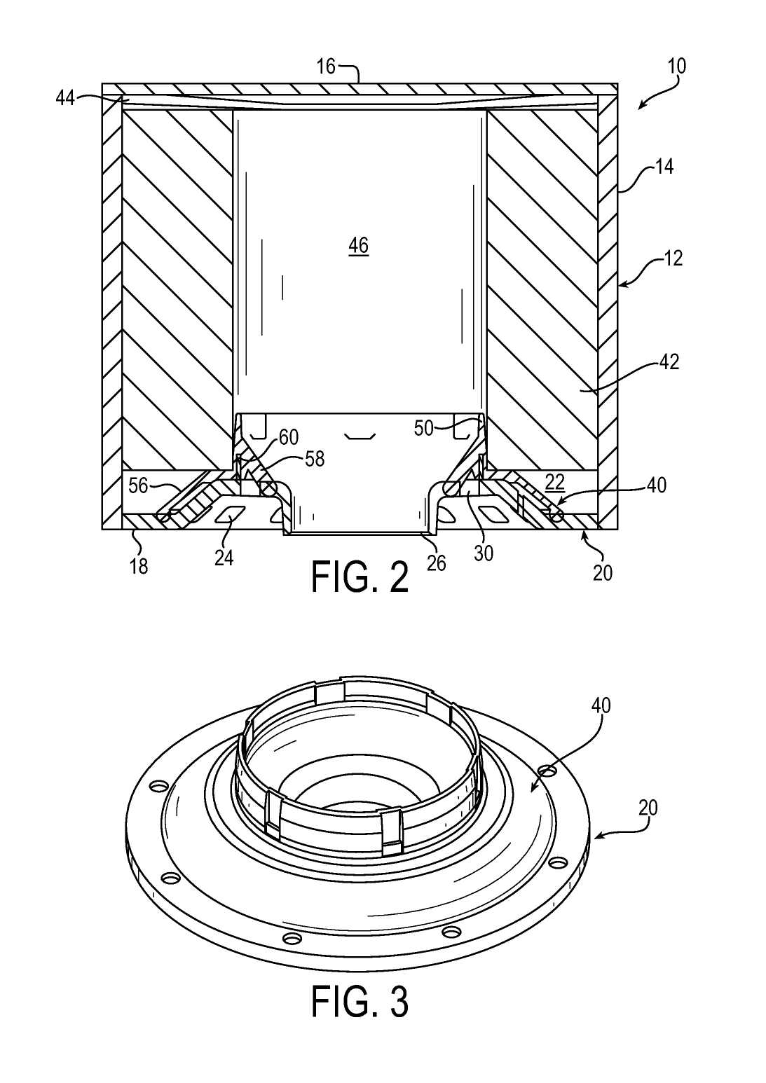

Turning now to FIGS. 1-3, an exemplary oil filter is illustrated generally at reference numeral 10. The oil filter 10 includes a housing 12 comprising a substantially cylindrical canister 14 having a closed end 16 and an open end 18. A base plate 20 is attached to the open end 18 of the canister 14, and defines an internal chamber 22 therewith. A plurality of circumferentially spaced inlet ports 24 for directing unfiltered fluid into the internal chamber 22 are provided in the base plate 20, and an outlet port 26, surrounded by the inlet ports 24, is provided in the base plate 20 for expelling filtered fluid from the chamber 22. The outlet port 26 includes threads 28, such as internal threads, for mating with threads on an engine block (not shown). A plurality of circumferentially spaced bypass ports 30 are provided in the base plate 20 between the inlet ports 24 and the outlet port 26 for fluid to flow through when a filter element is clogged. The base plate 20 also includes an annular groove 32 surrounding the inlet ports 24 for receiving an annular seal 34 that resists oil leakage outwardly from the base plate 20 when the oil filter 10 is coupled to an engine block.

Disposed in the internal chamber 22 are a combination anti-drainback/bypass valve 40, herein referred to as the combination valve, a suitable filter element 42, such as an outside-in pleated filter element, and a biasing member 44. The biasing member 44 applies a load to the filter element 42 during assembly, which biases the filter element 42 against the combination valve 40 to hold the combination valve 40 against the base plate 20. When the oil filter 10 is coupled to the engine block via the threads 28, fluid flows from the engine block through the plurality of inlet ports 24. The fluid flows past the anti-drainback valve 40, as will be described in detail below, to the filter element 42, where contaminants are removed from the fluid. The fluid then flows through the filter element 42 to a central portion 46 thereof, and out of the oil filter 10 through the outlet port 26.

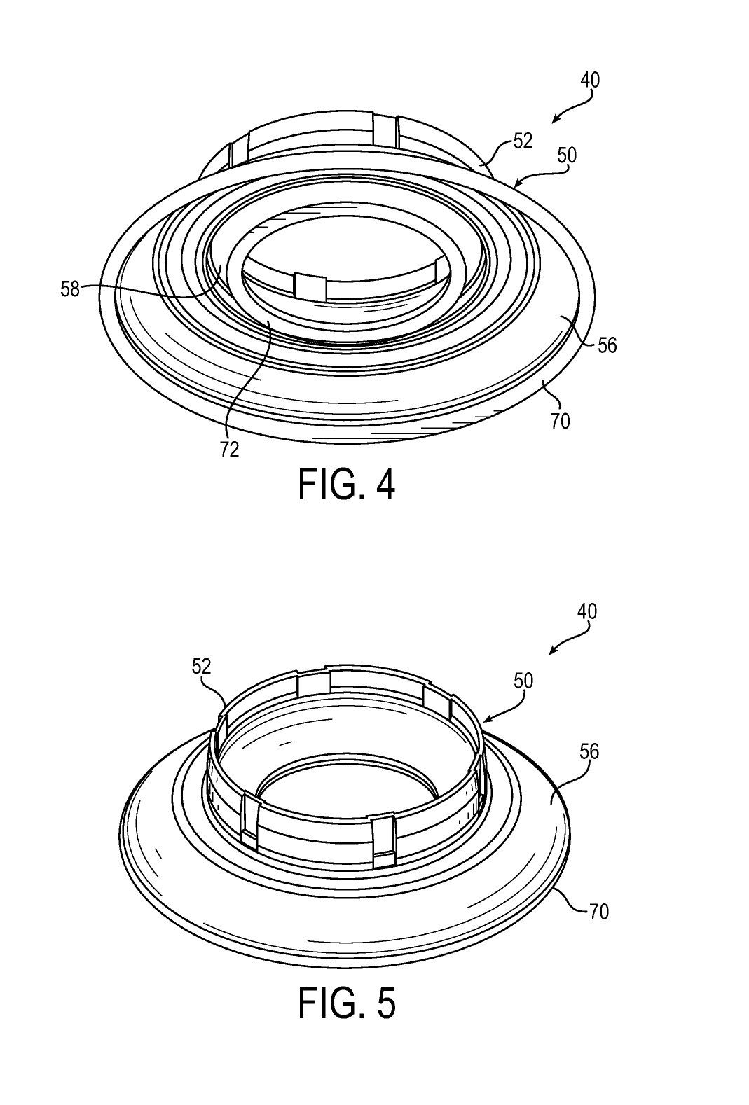

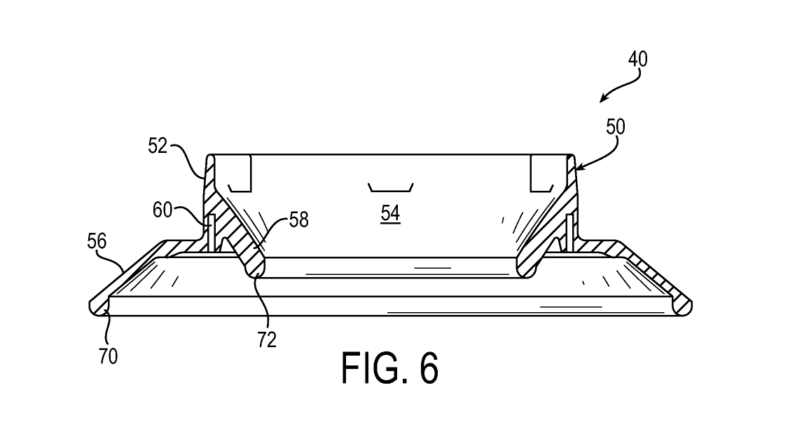

Referring now to FIGS. 4-6, the combination valve 40 will be discussed in detail. The combination valve 40 includes a body 50 having an annular base portion 52 defining a fluid passage 54 through the body 50, a resiliently deflectable annular anti-drainback skirt or annular check valve member 56, and a resiliently deflectable annular bypass skirt or annular check valve member 58. The annular base portion 52 may be received inside the filter element 42 and the filter element 42 abuts a side of the resiliently deflectable annular drainback skirt 56. The annular base portion 52 is characterized by being stiffer than the resiliently deflectable anti-drainback skirt 56 and the resiliently deflectable bypass skirt 58. The annular base portion 52, the resiliently deflectable anti-drainback skirt 56, and the resiliently deflectable bypass skirt 58 may be separate components coupled together in any suitable manner, or the base portion 52, the anti-drainback skirt 56, and the bypass skirt 58 may be unitary as shown. The body 50, and thus the base portion 52, the anti-drainback skirt 56, and the bypass skirt 58, may be made of any suitable material, such as a nitrile rubber, a silicone, etc.

The combination valve 40 also includes an annular ring member 60 that interacts with the annular base portion 52 to impart a greater stiffness on the annular base portion 52 than the resiliently deflectable anti-drainback skirt 56 and the resiliently deflectable bypass skirt 58. As shown, the annular ring member 60 is a relatively rigid member, such as a steel member, embedded in the annular base portion 52 in any suitable manner. For example, the annular base portion 52 may be molded over the annular ring member 60. The annular ring member 60 may be embedded in the annular base portion 52 between the resiliently deflectable anti-drainback skirt 56 and the resiliently deflectable bypass skirt 58. The annular ring member 60 provides stiffness to the annular base portion 52 so that the resiliently deflectable bypass skirt 58 opens at relatively high pressures and is prevented from opening when the pressure is below a desired pressure.

The resiliently deflectable annular anti-drainback skirt 56 extends radially outwardly from the annular base portion 52 and may also extend axially from the annular base portion 52 in a first direction. The resiliently deflectable annular bypass skirt 58 extends radially inwardly from the annular base portion 52 and may also extend axially from the annular base portion 52 in the first direction. The resiliently deflectable anti-drainback skirt 56 extends from the annular base portion 52 in the first direction a distance greater than the resiliently deflectable bypass skirt 58 extends from the annular base portion 52 in the first direction to seal against the base portion 20 at axially spaced locations.

The resiliently deflectable annular anti-drainback skirt 56 includes a sealing portion 70 for sealing to an outer portion of the base plate 20 and the resiliently deflectable annular bypass skirt 58 includes a sealing portion 72 for sealing to an inner portion of the base plate 20. The resiliently deflectable annular anti-drainback skirt 56 is movable between a first position sealing to the base plate 20 and a second position away from the base plate 20. The resiliently deflectable annular anti-drainback skirt 56 seals to the base plate 20 to keep oil in the oil filter 10 during engine shutoff to avoid dry starts, and moves away from the base plate 20 from fluid pressure to allow oil to flow through the openings 24 and into the filter element 42.

Similarly, the resiliently deflectable annular bypass skirt 58 is movable between a first position sealing to the base plate 20 and a second position away from the base plate 20. The resiliently deflectable annular bypass skirt 58 seals to the base plate 20 to prevent oil from bypassing the filter element 42 when the filter element 42 is not clogged, and moves away from the base plate 20 from fluid pressure when the filter element 42 is clogged to allow the oil to bypass the filter element 42. In this way, the engine is not starved of oil when the filter element 42 becomes clogged.

The resiliently deflectable annual bypass skirt 58 replaces a spring-loaded pressure relief valve at the closed end 16 of the oil filter 10. The resiliently deflectable annual bypass skirt 58 allows the area of the chamber 22 where the filter element 42 is disposed to be bypassed when the filter element 42 is clogged. By isolating the fluid from the contaminants in the filter element 42, the contaminants are prevented from being loosened by oil flowing past the filter element 42, thereby preventing the previously filtered out contaminants from entering the oil flowing to the engine. The elimination of the spring-loaded pressure relief valve also reduces components and assembly time of the oil filter 10.

The resiliently deflectable annular bypass skirt 58 is movable away from the base plate 20 to allow fluid flow into the fluid passage 54 of the combination valve 40 by fluid flowing through the plurality of bypass ports 30 at a fluid pressure at or above a prescribed criteria. In an embodiment, the prescribed criteria is a fluid pressure of twelve psi. In another embodiment, the prescribed criteria is a fluid pressure of fifteen psi. In still a further embodiment, the prescribed criteria is a fluid pressure of twenty psi.

During operation of a vehicle in which the oil filter 10 is installed, unfiltered oil flows from the engine to the oil filter 10. The unfiltered oil flows to the base plate 20 and through the plurality of inlet ports 24. The pressure of the unfiltered oil acts against the resiliently deflectable annular anti-drainback skirt 56 to move the anti-drainback skirt 56 from the first position where the sealing portion 70 seals against the base plate 20 to the second position where the unfiltered oil passes by the resiliently deflectable annular anti-drainback skirt 56 to the filter element 42. Contaminants are filtered from the oil in the filter element 42 and the filtered oil flows to the central portion 46 of the filter element 42. The filtered oil flows from the central portion 46 through the fluid passage 54 in the combination valve 40 to the base plate 20, where the filtered oil flows out of the outlet port 26 to the engine.

When the filter element 42 becomes clogged, the unfiltered oil is prevented or substantially prevented from flowing past the resiliently deflectable annular anti-drainback skirt 56 due to the clog. When this occurs, the oil pressure that is at the prescribed valve or which increases in pressure due to the clog to reach the prescribed value, flows through the plurality of bypass ports 30 in the base plate 20. The pressure of the oil, such as a pressure of twenty psi, acts against the resiliently deflectable annular bypass skirt 58 to move the bypass skirt 58 from the first position where the sealing portion 72 seals against the base plate 20 to the second position where the unfiltered oil flows into the fluid passage 54 of the combination valve 40 and to the outlet port 26 to bypass the filter element 42.

By providing a combination valve 40 that includes the annular ring member 60 that imparts a greater stiffness on the annular base portion 52 than the resiliently deflectable anti-drainback skirt 56 and the resiliently deflectable bypass skirt 58, a hinge area of the resiliently deflectable bypass skirt 58 is controlled to open at relatively high pressures, such as twenty psi. Controlling the hinge area of the bypass skirt 58 prevents failure of the resiliently deflectable bypass skirt 58 at pressures below the prescribed criteria, which prevents unfiltered oil from bypassing the filter element 42 when the filter element 42 is not clogged.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A combination anti-drainback/bypass valve for an oil filter, the combination anti-drainback/bypass valve including:
an annular base portion;
a resiliently deflectable annular anti-drainback skirt extending radially outwardly from the base portion; and
a resiliently deflectable annular bypass skirt extending radially inwardly from the base portion,
wherein the base portion is characterized by being stiffer than the resiliently deflectable anti-drainback skirt and the resiliently deflectable bypass skirt.

2. The combination anti-drainback/bypass valve according to claim 1, wherein the base portion is unitary with the resiliently deflectable anti-drainback skirt and the resiliently deflectable bypass skirt.

3. The combination anti-drainback/bypass valve according to claim 1, further including an annular ring member that interacts with the base portion to impart a greater stiffness on the base portion than the resiliently deflectable anti-drainback skirt and the resiliently deflectable bypass skirt.

4. The combination anti-drainback/bypass valve according to claim 1, wherein the annular ring member is embedded in the base portion.

5. The combination anti-drainback/bypass valve according to claim 4, wherein the annular ring member is embedded in the base portion between the resiliently deflectable anti-drainback skirt and the resiliently deflectable bypass skirt.

6. The combination anti-drainback/bypass valve according to claim 1, wherein the resiliently deflectable annular anti-drainback skirt extends from the base portion radially outwardly and axially in a first direction.

7. The combination anti-drainback/bypass valve according to claim 1, wherein the resiliently deflectable annular bypass skirt extends from the base portion radially inwardly and axially in a first direction.

8. The combination anti-drainback/bypass valve according to claim 7, wherein the resiliently deflectable anti-drainback skirt extends from the base portion in the first direction a distance greater than the resiliently deflectable bypass skirt extends from the base portion in the first direction.

9. The combination anti-drainback/bypass valve according to claim 1, wherein the base portion, the resiliently deflectable anti-drainback skirt, and the resiliently deflectable bypass skirt are made from the same material.

10. The combination anti-drainback/bypass valve according to claim 1, wherein the base portion defines a fluid passage therethrough.

11. The combination anti-drainback/bypass valve according to claim 1, wherein the resiliently deflectable anti-drainback skirt and the resiliently deflectable bypass skirt each have a sealing portion for sealing to a base member.

12. The combination anti-drainback/bypass valve according to claim 1, wherein the resiliently deflectable bypass skirt is movable from a first position to a second position by a fluid pressure at or above a prescribed criteria.

13. A combination anti-drainback/bypass valve for an oil filter, the combination anti-drainback/bypass valve including:
an annular base portion;
a first annular check valve member extending radially outwardly from the annular base portion;
a second annular check valve member extending radially inwardly from the annular base portion; and
a relatively rigid annular support member embedded in the annular base portion.

14. The combination anti-drainback/bypass valve according to claim 13, wherein the relatively rigid annular support member imparts a greater stiffness to the annular base portion than the first and second check valve members.

15. The combination anti-drainback/bypass valve according to claim 13, wherein the annular base portion is unitary with the first annular check valve member and the second annular check valve member.

16. The combination anti-drainback/bypass valve according to claim 13, wherein the annular support member is embedded in the base portion between the first check valve member and the second check valve member.

17. The combination anti-drainback/bypass valve according to claim 13, wherein the first and second check valve members are resiliently deflectable.

18. The combination anti-drainback/bypass valve according to claim 13, wherein the first annular check valve member extends from the annular base portion radially outwardly and axially in a first direction.

19. The combination anti-drainback/bypass valve according to claim 13, wherein the second annular check valve member extends from the annular base portion radially inwardly and axially in a first direction.

20. The combination anti-drainback/bypass valve according to claim 13, wherein the first check valve member extends from the base portion in the first direction a distance greater than the second check valve member extends from the base portion in the first direction.

21. The combination anti-drainback/bypass valve according to claim 13, wherein the base portion, the first check valve member, and the second check valve member are made from the same material.

22. The combination anti-drainback/bypass valve according to claim 13, wherein the base portion defines a fluid passage therethrough.

23. The combination anti-drainback/bypass valve according to claim 13, wherein the first and second check valve members each have a sealing portion for sealing to a base member.

24. The combination anti-drainback/bypass valve according to claim 13, wherein the second annular check valve member is movable from a first position to a second position by a fluid pressure at or above a prescribed criteria.

25. An oil filter including:
a housing including a canister having a closed end and an open end;
a base plate attached to the open end of the canister and defining an internal chamber therewith, the base plate including a plurality of circumferentially spaced inlet ports for directing unfiltered fluid into the internal chamber, an outlet port surrounded by the inlet ports for expelling filtered fluid from the chamber, and a plurality of circumferentially spaced bypass ports between the inlet ports and the outlet port for directing fluid to the outlet port;
a filter element disposed in the chamber; and
a combination anti-drainback/bypass valve disposed in the chamber between the base plate and the filter element, the combination valve including:
a base portion;
a resiliently deflectable annular anti-drainback skirt extending radially outwardly from the base portion for allowing fluid flow from the inlet ports to the filter element; and
a resiliently deflectable annular bypass skirt extending radially inwardly from the base portion for allowing fluid flow to bypass the filter element and flow to the outlet port,
wherein the base portion is characterized by being stiffer than the resiliently deflectable anti-drainback skirt and the resiliently deflectable bypass skirt.

26. The oil filter according to claim 25, further including a biasing member that applies a load to the filter element to bias the filter element against the combination valve to hold the combination valve against the base plate.

27. The oil filter according to claim 25, wherein the resiliently deflectable annular bypass skirt is movable from a first position sealing against the base plate to a second position allowing fluid to bypass the filter element and flow to the outlet port by a fluid pressure at or above a prescribed criteria.
